(19) United States
(12) Patent Application Publication
(10) Pub. No.: US 2003/0174714 A1
(43) Pub. Date: Sep. 18, 2003

(54) Zero-installation PPP-Bridge setup for lan-to-wan connectivity

(75) Inventors: Ravi Manik, Tustin, CA (US); Samir Jain, Irvine, CA (US); Ajay Sharma, Irvine, CA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: Globespan Virata, Inc., Red Bank, NJ (US)

(21) Appl. No.: 10/377,514

(22) Filed: Mar. 3, 2003

Related U.S. Application Data
(60) Provisional application No. 60/360,764, filed on Mar. 1, 2002.

(51) Int. Cl. H04L 12/28

(52) U.S. Cl. 370/396; 370/398

(57) ABSTRACT

A customer premise equipment (CPE) device operating in a combined bridge/router mode is disclosed herein. The CPE device may implement a PPP-based bridge in conjunction with a wide area network (WAN) client (e.g., a PPPoE or PPPoA client) to configure and establish a PPP-based link between the CPE device and an access concentrator connected to a WAN, eliminating the need for a WAN client at an end user device on a local area network (LAN) connected to the CPE device. The CPE device further may be adapted to assign a global IP address (e.g., the global IP address assigned to the CPE device) to the end user device, thereby facilitating data communication between the end user device and the WAN without requiring the use of network address translation (NAT) or a similar process at the CPE device.

### CROSS REFERENCE TO RELATED APPLICATIONS

Priority is claimed based on U.S. Provisional Application No. 60/360,764 entitled “Zero-Installation PPP-bridge setup for xDSL Modems,” filed Mar. 1, 2002, the entire disclosure of which is incorporated by reference herein.

### FIELD OF THE INVENTION

The present invention relates generally to data communications between local area networks (LANs) and wide area networks (WANs) and more particularly to implementing a Point-to-Point Protocol (PPP)-based bridge at a customer premise equipment (CPE) device to allow an end user device to communicate with a WAN-based network device without the use of a WAN client at the end user device.

### BACKGROUND OF THE INVENTION

The Point-to Point Protocol (PPP) has become the default standard for connecting customer premise access equipment (CPE) device, such as modems and routers, to remote access concentrators (e.g., dial-up connections maintained by internet service providers, or ISPs). PPP, as detailed by request for comments (RFC) 1548, describes a process for transporting IP packets over a physical link, incorporating error correction, diagnostics, security, and peer-to-peer negotiation. Likewise, PPP-based protocols, such as the PPP over Ethernet (PPPoE) protocol, the PPP over Asynchronous Transfer Mode (PPPoA) protocol and the PPP over HDLC protocol, are widely implemented protocols for PPP encapsulation over wide area network (WAN) interfaces.

PPP and PPP-based protocols are particularly useful in communications between network devices on a local area network (LAN) and remote network devices located on a WAN. In such cases, one or more network devices typically are connected to a CPE device via any of a number of types of LANs, such as, for example, an Ethernet-based LAN. In turn, the CPE device is connected to an access concentrator of the WAN via one or more physical network mediums, such as twisted pair cable, coaxial cable, fiber optics, wireless transmission devices, and the like. To transmit data from the network device of the LAN to the remote device on the WAN, a user of a network device typically directs the PPP protocol layer of the CPE device to establish a physical transport layer connection to the access concentrator over the physical network medium. The physical connection process performed by the PPP stack generally includes providing a user-supplied identification (ID) and password from the CPE device to the access concentrator, providing authentication information, receiving notification from the access concentrator that a link is established, and the like. After the physical connection is established based on user direction, the CPE device provides packets from the network device to the access concentrator, and vice versa, over the established physical connection. In this mode, the CPE device is operating in routing mode and typically requires the implementation of NAT on the CPE device.

In many instances, it may be desirable to configure the CPE device to operate in bridge mode such that the LAN and WAN are effectively connected as a single network with the CPE device acting as a bridge. One advantage of bridge mode operation, as opposed to router mode, is that network address translation (NAT) often is not required, thereby reducing the complexity of implementing the CPE device. Bridge mode CPE devices, however, often require a PPPoE/PPPoA adaptor (collectively referred to as a WAN client) at the end user device to keep track of an end user's activity and/or to provide authentication (i.e., login/logout). The WAN adaptor typically encapsulates network data transmitted between the CPE device/WAN and the end user device using a WAN protocol. Due to complexities incurred from the variations between WAN adaptor versions, end user device operating systems (OSs), and issues regarding royalties or licensing fees, the installation and use of WAN adaptors at the end user device often frustrates or prevents the successful installation and operation of PPP-based protocols over multiple network segments.

Accordingly, an improved process for establishing PPP-based connectivity which combines the benefits of both bridged and routed modes would be advantageous.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, transparent operation, cost savings, etc.

In a distributed network comprising a customer premise equipment (CPE) device connected to an end user device via a local area network (LAN) and an access concentrator via a wide area network (WAN), a method for providing data communications between the end user device and the access concentrator in accordance with at least one embodiment of the present invention. The method comprises the steps of establishing a Point-to-Point Protocol (PPP)-based connection between the CPE device and the access concentrator, wherein the CPE device is assigned a global Internet Protocol (IP) address as a result of the PPP-based connection, assigning the global IP address to the end user device, bridging at least one data packet received at the CPE from the end user device to the access concentrator, wherein a source IP address of the at least one data packet is the global IP address and bridging at least one data packet received at the CPE from the access concentrator to the end user device, wherein a destination IP address of the at least one data packet is the global IP address.

In accordance with another embodiment of the present invention, a customer premise equipment (CPE) device connected to an end user device via a local area network (LAN) and an access concentrator via a wide area network (WAN) is provided. The CPE device comprises a WAN interface operably connected to the access concentrator and having a global Internet Protocol (IP) address, a LAN interface operably connected to the end user device and having a local IP address, a WAN client operably connected to the WAN interface and being adapted to establish a Point-to-Point Protocol (PPP)-based connection with the access concentrator and a PPP bridge operably connected to the LAN interface, the WAN client and the WAN interface and being adapted to bridge data packets received at the WAN interface from the access concentrator to the LAN interface for transmission to the end user device and bridge data packet received at the LAN interface from the end user device to the WAN interface for transmission to the access concentrator. The end user device has a same global IP address as the global IP address of the WAN interface.

One advantage of the present invention includes simplified user connectivity between a local area network and a wide area network. Another advantage includes decreased user effort to install and maintain software providing such connectivity.

Still further features and advantages of the present invention are identified in the ensuing description, with reference to the drawings identified below.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a schematic diagram illustrating an exemplary network system having a customer premise equipment (CPE) device operating in a combined bridge/router mode in accordance with at least one embodiment of the present invention.

FIG. 2 is a flow diagram illustrating an exemplary configuration process of the network system of FIG. 1 in accordance with at least one embodiment of the present invention.

FIGS. 3A and 3B are schematic diagrams illustrating an exemplary configuration of the network system of FIG. 1 using the process of FIG. 2 in accordance with at least one embodiment of the present invention.

### DETAILED DESCRIPTION OF THE INVENTION

The following description is intended to convey a thorough understanding of the present invention by providing a number of specific embodiments and details involving LAN to WAN data transmission in networks using PPP-based protocols. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

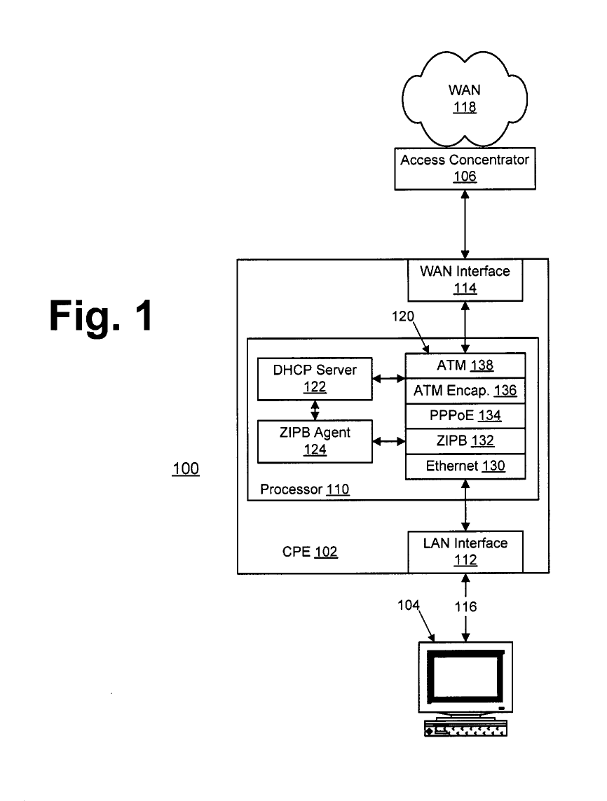

FIGS. 1-3B illustrate exemplary embodiments for providing transparent connectivity between local area networks (LANs) and wide area networks (WANs). In at least one embodiment, a customer premise access equipment (CPE) device is adapted to operate as a combined bridge/router between at least one LAN and at least one WAN using one or more LAN-to-WAN connectivity protocols (i.e., PPPoE and PPPoA) without requiring the installation of a WAN client at the end user device on the LAN. The CPE device may incorporate a PPP bridge in conjunction with a WAN client to provide PPP-based connectivity between the LAN and the WAN, thereby eliminating the need to implement a WAN client at the end user device. The CPE device further may be adapted to assign the global IP address of the WAN interface of the CPE device to the end user device, thereby eliminating the need for NAT or a similar process at the CPE device when transmitting data between the end user device and the WAN.

Referring now to FIG. 1, an exemplary network system 100 is illustrated in accordance with at least one embodiment of the present invention. The exemplary system 100, as shown, includes a CPE device 102 connected to one or more end user devices 104 (via a LAN 116) and an access concentrator 106. The access concentrator 106 in turn is connected to one or more WANs 118. The end user device 104 can include any of a variety of network-enabled devices, such as a desktop computer, a notebook computer, a handheld wireless device, a data server, a networked printer, a router and the like. Similarly, the CPE device 102 may include any of a variety of CPE devices (also known as gateways) utilized as an interface between a local network (e.g., a LAN) and the access concentrator 106, such as a dial-up modem, an asynchronous or synchronous digital subscriber line (xDSL) modem, a cable modem, a router and the like. For ease of illustration, the CPE device 102 is discussed herein in the context of an xDSL modem. The network medium utilized in the LAN 116 can include any of a variety of network mediums suitable for implementation in a LAN, such as an Ethernet network, an ATM network, an IEEE 802.11b wireless network, and the like.

The access concentrator 106 can include any of a variety of access concentrator devices appropriate to the CPE device 102. To illustrate, if the CPE device 102 includes an analog dial-up modem, then the access concentrator 106 could include a bank of modems adapted to receive incoming calls. Likewise, if the CPE device 102 includes a DSL modem, then the access concentrator typically would include a DSL access multiplexer (DSLAM). The network medium connecting the CPE device 102 to the access concentrator 106 may include any of a variety of WAN mediums compatible with the CPE device 102 and the access concentrator 106, such as a DSL/ATM medium (e.g., twisted pair, coaxial cable, etc.), a wireless medium, and the like.

In the illustrated embodiment, the CPE device 102 includes at least a LAN interface 112 to interface with the end user device 104 via the LAN 116, a WAN interface 114 adapted to interface with the access concentrator 106/WAN 118, and a processor 110 adapted to receive data received from the interfaces 112, 114 and process the data accordingly using one or more protocol stacks 120. The LAN interface 112 may comprise any of a variety of LAN interfaces appropriate to the network medium, such as, for example, an Ethernet interface, a token ring interface, an ATM interface, a universal serial bus (USB) interface, a FireWire interface, an IEEE 802.11b interface, and the like. The WAN interface 114 can include any of a variety of network interfaces suitable to the WAN network medium, such as, for example, a Utopia interface, an ATM over optical fiber interface, a cable modem interface, a dial-up modem interface, a wireless interface, and the like.

The protocol stack 120 may include any of a variety of protocol layers as appropriate to the protocols utilized by the interfaces 112, 114 and/or the access concentrator 106. For example, in the illustrated embodiment, the protocol stack 120 includes protocol layers conventionally found in xDSL modem implementation of the CPE device 102, such as an Ethernet layer 130, a PPPoE layer 134, an ATM encapsulation layer 136, and an ATM layer 138. Although an exemplary implementation of the network protocol stack 120 having the above combination of protocol layers is illustrated for ease of discussion, it would be well understood by one skilled in the art to use other protocol layers and/or combinations thereof without departing from the spirit or the scope of the present invention. To illustrate, a PPPoA layer could be used in place of the PPPoE layer 134 (with the appropriate changes in the other layers of the protocol stack 120) to provide various types of LAN-to-WAN connectivity. Likewise, although the protocol stack 120, in one embodiment, includes a protocol layer based on the PPP protocol (RFC 1548), other point-to-point protocols may be utilized in accordance with the present invention, such as the Serial Line Internet Protocol (RFC 1055) or the High-Level Data Link Control (HDLC) protocol, and the like.

The protocol stack 120 further includes a zero installation PPP bridge (ZIPB) 132 located at the network layer (e.g., Layer 3 of the International Standard Organization's Open System Interconnect (ISO/OSI) network model) of the protocol stack 120. In at least one embodiment, the ZIPB 132 implements or augments the operation of the network layer (not shown). The ZIPB 132 may be adapted to provide a bridge between the LAN interface 112 and the WAN interface 114 so that the end user device 104 and the access concentrator 106/WAN 118 operate as though they were on the same network segment. Upon receipt of an Ethernet frame from the end user device 104, the ZIPB 132 may be adapted to strip the original Ethernet header and add a new header in accordance with the protocol layer 134. For example, if the PPP protocol is PPPoE, the ZIPB 132 can be adapted to add a PPPoE header followed by an Ethernet header when providing the data to the lower protocol layers 136, 138 for transmission over WAN interface 114. In this case, the Ethernet header may be formatted to have the WAN interface 114 as the source interface and the access concentrator 106 as the destination interface. Frames received from WAN 118 having packets intended for the end user device 104, may be processed by the ATM layers 136, 138 (e.g., deencapsulated by the ATM encapsulation layer 136) and the PPPoE header removed by the PPPoE layer 134. The ZIPB 132 then may remove the original Ethernet header and add a new Ethernet header to indicate the LAN interface 112 as the source interface and the end user device 104 as the destination interface.

By adapting the ZIPB 132 to act in a manner similar to a router while supporting a WAN client at the CPE device 102, the installation of a WAN client (e.g., a PPPoE/PPPoA client) on the end user device 104 and the use of NAT at the CPE device 102 may not be required, thereby easing the integration of an end user device 104 into the system 100.

The CPE device 102, in one embodiment, further includes a Dynamic Host Configuration Protocol (DHCP) server 122 and a zero-installation PPP bridge (ZIPB) agent 124. The DHCP server 122 may be adapted to assist in the configuration of the IP addresses and gateway IP addresses used by the interfaces 112, 114 and the one or more end user devices 104. The operation of a DHCP server is well known to those skilled in the art. As discussed in greater detail below, the ZIPB agent 124 may be adapted to adjust the local and global IP addresses used by the DHCP server 122 (and, by extension, the interfaces 112, 114 and end user device 104) as well as configure and manage the operation of the ZIPB 132 and/or other layers of the protocol stack 120.

In the illustrated embodiment, the protocol stack 120, DHCP server 122 and ZIPB agent 124 are implemented at least in part as executable instructions adapted to manipulate the processor 110 to perform the associated functions, where the processor 110 may include a general purpose processor, a communications processor, an application specific integrated circuit (ASIC), and the like. Alternatively, one or more of the protocol stack 120, DHCP server 122 and ZIPB agent 124 may be implemented as executable instructions executed by a separate processor, as a hardware/firmware component, and the like.

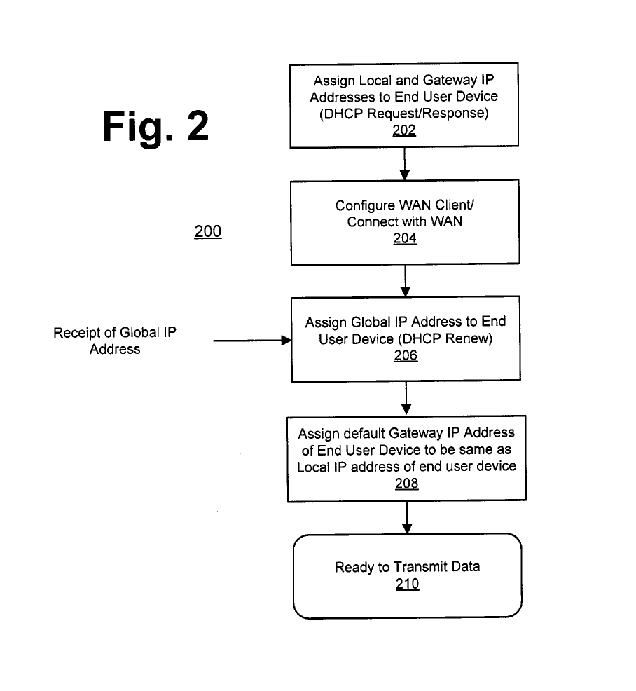

Referring now to FIG. 2, an exemplary configuration process 200 of the system 100 is illustrated in accordance with at least one embodiment of the present invention. As described below, the CPE device 102 preferably operates in a combination bridge/router mode between the LAN 116 and WAN 118 through a manipulation of the IP addresses and/or gateway IP addresses assigned to and used by the interfaces 112, 114 and the end user device 104 such that NAT (and similar processes) is not needed in transmitting packets between the LAN 116 and WAN 118. As a result, NAT may not be required at the CPE device 102 as a result of the global IP address used by the end user device 104. Additionally, the use of the PPP bridge (ZIPB 132) and the WAN client (e.g., PPPoE layer 134), typically eliminates the need for a WAN client at the end user device 104. The configuration process 200 initiates at step 202, whereby the local IP address and gateway address used by the end user device 104 may be set by the DHCP server 122. Prior to configuring the local IP addresses associated with the end user device 104, the DHCP server 122 may be enabled with a known set of local IP and gateway addresses. The end user device 104 may be leased one of these local IP addresses upon request (e.g., a DHCP RENEW command) for a given time period, such as, for example, one minute.

At step 204, a WAN client at the CPE device 102 (e.g., the PPPoE layer 134, FIG. 1) establishes a connection between the CPE device 102 and the access concentrator 106 using the appropriate. In general, PPP-based WAN connection techniques, such as PPPoE and PPPoA, require user input before establishing a physical connection over the network medium between the CPE device 102 and the access concentrator 106. This input typically includes the end user manually supplying a user ID and password, providing connection settings such as bit parity, and directing the CPE device 102 to initiate the connection negotiations with the supplied information. In an alternate embodiment, the ZIPB agent 124, PPPoE layer 134 or other component of the CPE device 102 can be adapted to establish the connection and provide the required information without input from the end user.

As part of the process of establishing a connection between the access concentrator 106 and the CPE device 102, the access concentrator 106 typically assigns a global IP address to the WAN interface 114 of the CPE device 102 for use in addressing packets from the WAN 118/access concentrator 106 to the CPE device 102. Upon receipt of this global IP address, the ZIBP agent 124, in one embodiment, is adapted to adjust the DHCP server 122 so that the IP address associated with the end user device 104 is the global IP address received from the access concentrator 106. Accordingly, when the end user device 104 performs a DHCP RENEW at the end of the lease period for the initial IP address (or upon a DHCP FORERENEW by the DHCP server 122), the DHCP server 122, in one embodiment, assigns the access-concentrator-supplied IP address to the end user device 104. At this point, the wan interface 114 and the end user device 104 share the global IP address assigned by the access concentrator 106.

At step 208, the default gateway address of the end user client 104 may be changed to the local (self) IP address of the LAN interface 112. As with the assignment of the IP address of the end user device 104, the assignment of the gateway address may be accomplished using, for example, a DHCP RENEW command by the end user device 104 or a DHCP FORCERENEW command by the DHCP server 122, preferably at the direction of the ZIPB agent 124 (e.g., as part of the DCHP RENEW sequence of step 206).

At step 210, the CPE device 102 is configured to provide connectivity between the end user device 104 and the WAN 118 without requiring the use of a WAN client at the end user device 104 or NAT at the CPE device 102, thereby reducing the difficulties in installing and maintaining software at the end user device 104. An additional advantage of the combined bridge/router mode of the CPE device 102 is that a variety of WAN protocols (e.g., PPPoA and PPPoE) may be used at the CPE as the WAN client (e.g., PPPoE layer 134) is executed at the CPE device 102 rather than on the end user device 104.

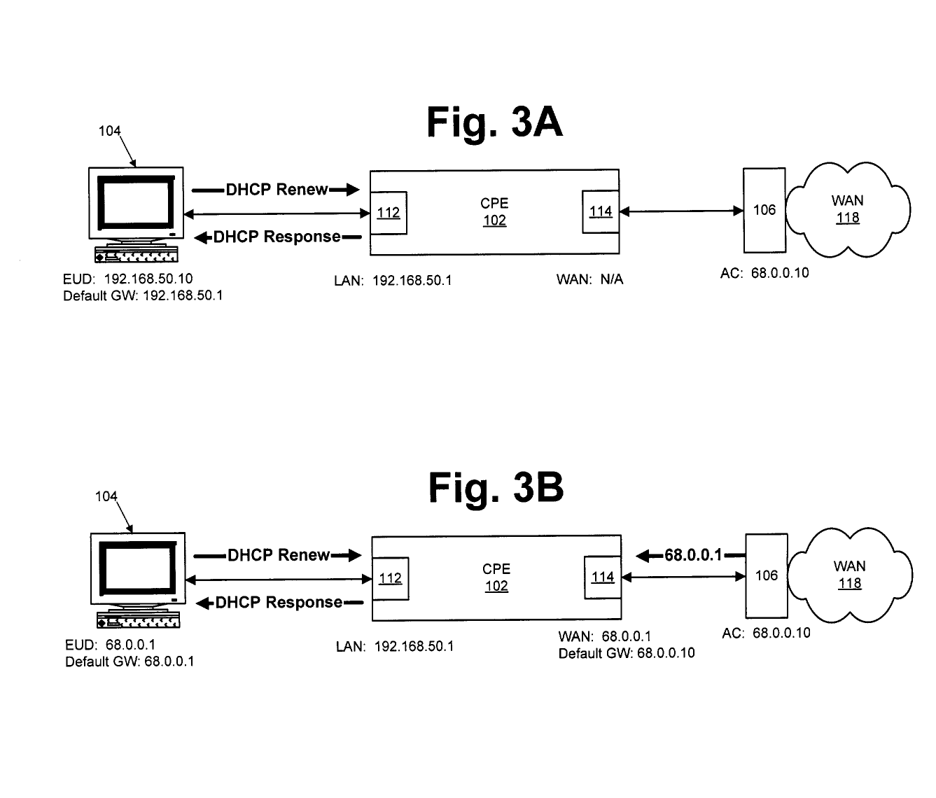

Referring now to FIGS. 3A and 3B, an example of the configuration process 200 is illustrated in accordance with at least one embodiment of the present invention. As illustrated in FIG. 3A, the end user device 104 is assigned an exemplary local IP address of 192.168.50.10 by the DHCP server 122 (step 202, FIG. 2) using a DHCP RENEW and DHCP RESPONSE sequence. The LAN interface 112, in this example, initially is assigned a local IP address of 192.168.50.1 and the default gateway address of the end user device 104 is set to the local IP address of the LAN interface 112. The CPE device 102 then may establish a WAN connection (step 204, FIG. 2).

As illustrated in FIG. 3B, the access concentrator 106 provides a global IP address of, for example, 68.0.0.1 to the CPE device 102. The CPE device 102 then may assign this global IP address to the WAN interface 114. The ZIPB agent 124 then may configure the DHCP server 122 to assign the global IP address provided by the access concentrator 106 to the end user device 104. Accordingly, at the next DHCP RENEW and DHCP RESPONSE sequence (step 206, FIG. 2), the DHCP server 122 assigns the IP address 68.0.0.1 to the end user device.

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof.

What is claimed is:

1. In a distributed network comprising a customer premise equipment (CPE) device connected to an end user device via a local area network (LAN) and an access concentrator via a wide area network (WAN), a method for providing data communications between the end user device and the access concentrator comprising the steps of:
establishing a Point-to-Point Protocol (PPP)-based connection between the CPE device and the access concentrator, wherein the CPE device is assigned a global Internet Protocol (IP) address as a result of the PPP-based connection;
assigning the global IP address to the end user device;
bridging at least one data packet received at the CPE from the end user device to the access concentrator, wherein a source IP address of the at least one data packet is the global IP address; and
bridging at least one data packet received at the CPE from the access concentrator to the end user device, wherein a destination IP address of the at least one data packet is the global IP address.

2. The method as in claim 1, wherein the step of assigning the global IP address includes assigning the global IP address using a dynamic host control protocol (DHCP) server at the CPE device.

3. The method as in claim 1, wherein the step of bridging the at least one data packet from the end user device to the access concentrator includes removing an original header and adding a new header based at least in part on the WAN adaptor.

4. The method as in claim 1, wherein the step of bridging the at least one data packet from the access concentrator to the end user device includes removing an original header and adding a new header based at least in part on the LAN adaptor.

5. The method as in claim 1, wherein the PPP-based connection includes one of a group consisting of: a Point-to-Point over Ethernet (PPPoE) connection and a Point-to-Point over Asynchronous Transfer Mode (PPPoA) connection.

6. The method as in claim 1, wherein the CPE device includes one of a group consisting of: a dial-up modem, an digital subscriber line (xDSL) modem, a cable modem, and a router.

7. A customer premise equipment (CPE) device connected to an end user device via a local area network (LAN) and an access concentrator via a wide area network (WAN), the CPE device comprising:
a WAN interface operably connected to the access concentrator and having a global Internet Protocol (IP) address;
a LAN interface operably connected to the end user device and having a local IP address;
a WAN client operably connected to the WAN interface and being adapted to establish a Point-to-Point Protocol (PPP)-based connection with the access concentrator; and
a PPP bridge operably connected to the LAN interface, the WAN client and the WAN interface and being adapted to:
bridge data packets received at the WAN interface from the access concentrator to the LAN interface for transmission to the end user device; and
bridge data packet received at the LAN interface from the end user device to the WAN interface for transmission to the access concentrator;
wherein the end user device has a same global IP address as the global IP address of the WAN interface.

8. The CPE device as in claim 7, wherein the global IP address is assigned by the access concentrator as a result of the PPP-based connection established by the WAN client.

9. The CPE device as in claim 8, wherein the CPE device further includes a dynamic host configuration protocol (DHCP) server operably connected to the LAN interface and being adapted to configure the end user device to use the global IP address of the WAN interface.

10. The CPE device as in claim 7, wherein the PPP-based connection includes one of a group consisting of: a Point-to-Point over Ethernet (PPPoE) connection and a Point-to-Point over Asynchronous Transfer Mode (PPPoA) connection.

11. The CPE device as in claim 10, wherein the WAN client includes one of a group consisting of: a Point-to-Point over Ethernet (PPPoE) client and a Point-to-Point over Asynchronous Transfer Mode (PPPoA) client.

12. The CPE device as in claim 7, wherein a gateway address for the end user device includes the global IP address.

13. The CPE device as in claim 7, wherein the PPP bridge is implemented as at least part of a network protocol stack.

14. The CPE device as in claim 7, wherein the CPE device includes one of a group consisting of: a dial-up modem, an digital subscriber line (xDSL) modem, a cable modem, and a router.

15. In a distributed network comprising a customer premise equipment (CPE) device connected to an end user device via a local area network (LAN) and an access concentrator via a wide area network (WAN), a computer readable medium, the computer readable medium including a set of executable instructions adapted to manipulate a processor to:
establish a Point-to-Point Protocol (PPP)-based connection between the CPE device and the access concentrator, wherein the CPE device is assigned a global Internet Protocol (IP) address as a result of the PPP-based connection;
assign the global IP address to the end user device;
bridge at least one data packet received at the CPE from the end user device to the access concentrator, wherein a source IP address of the at least one data packet is the global IP address; and
bridge at least one data packet received at the CPE from the access concentrator to the end user device, wherein a destination IP address of the at least one data packet is the global IP address.

16. The computer readable medium as in claim 15, wherein the set of executable instructions adapted to manipulate the processor to bridge the at least one data packet from the end user device to the access concentrator includes executable instructions adapted to manipulate the processor to add a header to the at least one data packet, the header having the CPE device as a source address and the access concentrator as a destination address.

17. The computer readable medium as in claim 15, wherein the set of executable instructions adapted to manipulate the processor to bridge the at least one data packet from the end user device to the access concentrator includes executable instructions adapted to manipulate the processor to add a header a header to the at least one data packet, the header having the CPE device as a source address and the end user device as a destination address.

18. The computer readable medium as in claim 15, wherein the PPP-based connection includes one of a group consisting of: a Point-to-Point over Ethernet (PPPoE) connection and a Point-to-Point over Asynchronous Transfer Mode (PPPoA) connection.

19. The computer readable medium as in claim 15, wherein the CPE device includes one of a group consisting of: a dial-up modem, an digital subscriber line (xDSL) modem, a cable modem and a router.
